(19) United States
(12) Patent Application Publication
(10) Pub. No.: US 2009/0298569 A1
(43) Pub. Date: Dec. 3, 2009

(54) Method of Gaming, A Gaming System and a Game Controller

(76) Inventors: Scott Sims, Las Vegas, NV (US); Linn Anthony McKay, Henderson, NV (US)

Correspondence Address: MCANDREWS HELD & MALLOY, LTD, 500 WEST MADISON STREET, SUITE 3400, CHICAGO, IL, 60661, US

(21) Appl. No.: 12/434,498

(22) Filed: May 1, 2009

Related U.S. Application Data
(60) Provisional application No. 61/049,675, filed on May 1, 2008.

(51) Int. Cl. A63F 9/24; A63F 13/00

(52) U.S. Cl. 463/20; 463/30

(57) ABSTRACT

A method of gaming comprising: selecting a set of symbols for display to a player in a set of display positions; determining whether to provide an additional bonus symbol in association with one or more of the display positions; activating a bonus feature if a number of bonus symbols is at least a bonus threshold; and determining a game round outcome based at least on the selected symbols.

### RELATED APPLICATIONS

This application claims priority to U.S. Provisional Patent Application No. 61/049,675 having a filing date of May 1, 2008, which is incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates to a method of gaming, a gaming system and a game controller.

Gaming systems are known comprising a game controller arranged to randomly display several symbols from a predetermined set of symbols and to determine a game outcome such as a game win based on the displayed symbols. Such gaming systems may commonly be implemented as a video machine with selected symbols are displayed in virtual display positions corresponding for example to playing cards, on a video display.

Commonly bonus symbols can appear during such games which signify that the player has been awarded a free game or other similar bonus.

There is a need for alternative or enhanced methods and systems for awarding free games and other bonuses to add to player enjoyment.

### BRIEF SUMMARY OF THE INVENTION

According to a first aspect of the invention there is provided a method of gaming comprising:

selecting a set of symbols for display to a player in a set of display positions;

determining whether to provide an additional bonus symbol association with one or more of the display positions;

activating a bonus feature if a number of bonus symbols is at least a bonus threshold; and

determining a game round outcome based at least on the selected symbols.

In one embodiment the symbols selected for display are symbols of playing cards for an initial deal of poker. In an embodiment the player may replace one or more cards in subsequent deals and the method comprises determining in respect of each replaced card whether to provide a bonus symbol at its corresponding display position.

In one embodiment the bonus threshold is three.

In one embodiment the step of activating the bonus feature comprises awarding at least one free game round.

In one embodiment the step of determining the game round outcome is also based on the bonus feature. In an embodiment the step of determining the game round outcome comprises increasing prize amounts if the bonus feature is activated.

In one embodiment a plurality of additional bonus symbols may be provided at each display position. In an embodiment each bonus symbol surrounds the selected symbol at the display position.

According to a second aspect of the invention there is provided a gaming system comprising:

a display for symbols to be displayed in a set of display positions to a player;

a symbol selector for selecting a set of symbols for display in the display positions;

an additional bonus symbol provider for providing a one or more additional bonus symbols associated with one of more of the display positions in response to determining that one or more additional bonus symbols should be provided;

a bonus feature activator for activating a bonus feature if a number of bonus symbols is at least a bonus threshold; and

an outcome determiner for determining a game round outcome based at least on the selected symbols.

In one embodiment the symbol selector is adapted to display symbols of playing cards for an initial deal of poker. In an embodiment the player may replace one or more cards in subsequent deals and the additional bonus symbol provider is adapted to determine in respect of each replaced card whether to provide an additional bonus symbol at its corresponding display position.

In one embodiment the bonus threshold is three.

In one embodiment the step bonus feature activator is adapted to award at least one free game round.

In one embodiment the game round outcome determiner is adapted to determined the game round outcome also on the basis of the bonus feature. In an embodiment the game round outcome determiner is adapted to increase prize amounts if the bonus feature is activated.

In one embodiment the additional bonus symbol provider is adapted to provide a plurality of additional bonus symbols associated with a display position. In an embodiment the additional bonus symbol provider is adapted to provide each bonus symbol such that it surrounds the selected symbol at the display position.

In an embodiment, the gaming system comprises a game play mechanism operable by a player to make a wager and initiate a play of the game.

In an embodiment, the gaming system comprises a processor arranged to execute code stored in a memory to implement the symbol selector, additional symbol provider, bonus feature activator and outcome determiner.

According to a third aspect of the invention there is provided a game controller comprising

a symbol selector for selecting a set of symbols for display on a display to a player in a set of display positions;

an additional bonus symbol provider for providing a one or more additional bonus symbols associated with one of more of the display positions in response to determining that one or more additional bonus symbols should be provided;

a bonus feature activator for activating a bonus feature if a number of additional bonus symbols provided is at least a bonus threshold; and

an outcome determiner for determining a game round outcome based at least on the selected symbols.

In one embodiment the symbol selector is adapted to select symbols of playing cards for an initial deal of poker. In an embodiment the player may replace one or more cards in subsequent deals and the additional bonus symbol provider is adapted to determine in respect of each replaced card whether to provide an additional bonus symbol at its corresponding display position.

In one embodiment the bonus threshold is three.

In one embodiment the step bonus feature activator is adapted to award at least one free game round.

In one embodiment the game round outcome determiner is adapted to determined the game round outcome also on the basis of the bonus feature.

In an embodiment the game round outcome determiner is adapted to increase prize amounts if the bonus feature is activated.

In one embodiment the additional bonus symbol provider is adapted to provide a plurality of additional bonus symbols associated with a display position. In an embodiment the additional bonus symbol provider is adapted to provide each bonus symbol such that it surrounds the selected symbol at the display position.

In one embodiment at least one of the symbol selector, the additional bonus symbol provider, the bonus feature activator and the outcome determiner is implemented at least in part, by a processor executing code stored in a memory.

According to a fourth aspect of the invention there is provided a gaming system comprising:

means for displaying symbols in a set of display positions to a player;

means for selecting a set of symbols for display in the display positions;

means for providing a one or more additional bonus symbols associated with one of more of the display positions in response to determining that one or more additional bonus symbols should be provided;

means for activating a bonus feature if a number of additional bonus symbols provided is at least a bonus threshold; and

means for determining a game round outcome based at least on the selected symbols.

According to a fifth aspect of the invention there is provided an electronic gaming machine comprising:

a display for displaying a game including displaying symbols in a set of display positions to a player;

at least one input device operable to initiate a play of the game;

a game controller comprising a processor and a memory storing computer readable instructions, the processor executing the program code to implement the game in which the game controller selects a set of symbols for display in the display positions, the game controller determines whether one or more additional bonus symbols should be provided, the game controller provides one or more additional bonus symbols associated with one of more of the display positions in response to determining that one or more additional bonus symbols should be provided, the game controller activates a bonus feature if a number of additional bonus symbols provided is at least a bonus threshold, and the game controller determines a game round outcome based at least on the selected symbols.

According to a sixth aspect of the invention there is provided computer program code when executed by a computer causes the computer to implement any of the embodiments of the method of gaming of the first aspect of the invention.

According to a seventh aspect of the invention there is provided a computer readable medium comprising the program code of the sixth aspect of the invention.

According to an eighth aspect of the invention there is provided a data signal comprising the computer program code of the sixth aspect of the invention.

### BRIEF DESCRIPTION OF SEVERAL VIEWS OF THE DRAWINGS

FIG. 1 is a block diagram of the core components of a gaming system.

FIG. 2 is a perspective view of a stand alone single player gaming machine;

FIG. 3 is a block diagram of the functional components of a gaming machine;

FIG. 4 is a schematic diagram of the functional components of a memory;

FIG. 5 is a schematic diagram of a network gaming system;

FIG. 6 is a further block diagram of the multiplayer gaming system of the current invention;

FIG. 7 shows a flow diagram for the method of an embodiment of the invention; and

FIGS. 8A, 8B, and 8C is a display as viewed during stages of a game according to an embodiment of the invention.

### DETAILED DESCRIPTION OF THE INVENTION

Referring to the drawings, there is shown a gaming system having a game controller arranged to implement a game, such as a card game, in which additional bonus symbols may be awarded which may result in activation of a bonus feature independently of the outcome of the rest of the game. In one embodiment the bonus feature is an additional prize.

The gaming system may take a number of different forms. In a first form of the single player component of the invention, a stand alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

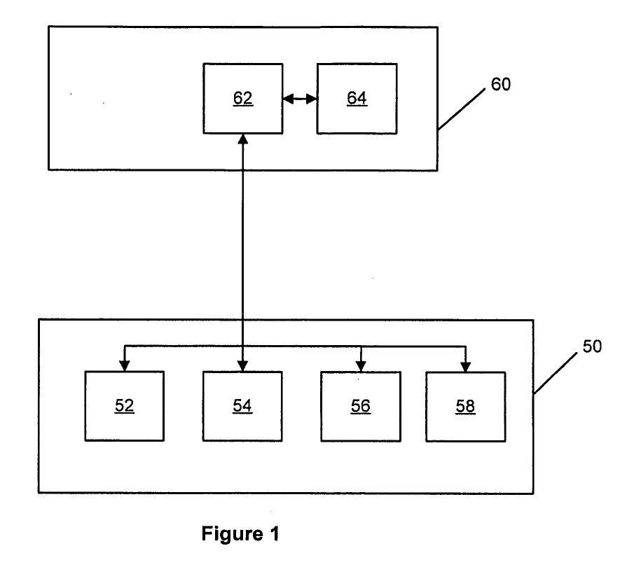

Irrespective of the form, the gaming system comprises several core components. At the broadest level, the core components are a player interface 50 and a game controller 60 as illustrated in FIG. 1. The player interface is arranged to enable manual interaction between a player and the gaming system and for this purpose includes the input/output components required for the player to enter instructions and play the game.

Components of the player interface may vary from embodiment to embodiment but will typically include a credit mechanism 52 to enable a player to input credits and receive payouts, one or more displays 54, a game play mechanism 56 comprising one or more input devices that enable a player to input game play instructions (e.g. to place bets), and one or more speakers 58.

The game controller 60 is in data communication with the player interface and typically includes a processor 62 that processes the game play instructions in accordance with game play rules and outputs game play outcomes to the display. Typically, the game play instructions are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server.

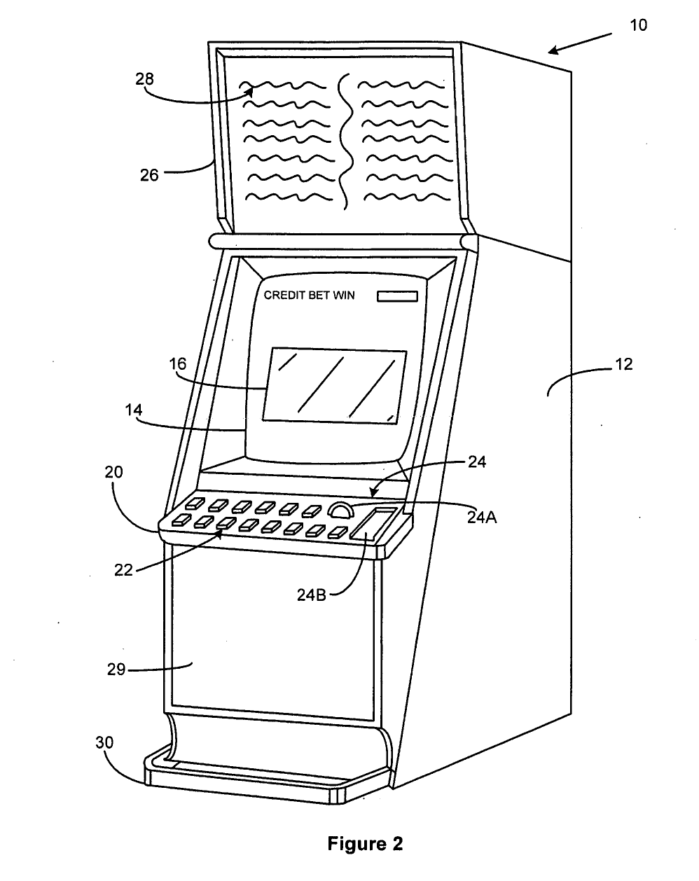

A gaming system in the form of a stand alone gaming machine 10 is illustrated in FIG. 2. The gaming machine 10 includes a console 12 having a display 14 on which are displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. A player marketing module (not shown) having a reading device may also be provided for the purpose of reading a player tracking device, for example as part of a loyalty program. The player tracking device may be in the form of a card, flash drive or any other portable storage medium capable of being read by the reading device.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

FIG. 3 shows a block diagram of operative components of a typical gaming machine which may be the same as or different to the gaming machine of FIG. 2.

The gaming machine 100 includes a game controller 101 having a processor 102. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 comprise one or more displays 106, a touch screen and/or buttons 107, a card and/or ticket reader 108, a printer 109, a bill acceptor and/or coin input mechanism 110 and a coin output mechanism 111. Additional hardware may be included as part of the gaming machine 100, or hardware may be omitted as required for the specific implementation. For example, while buttons or touch screens are typically used in gaming machines to allow a player to place a wager and initiate a play of a game any input device that enables the player to input game play instructions may be used. For example, in some gaming machines a mechanical handle is used to initiate a play of the game.

In addition, the gaming machine 100 may include a communications interface, for example a network card 112. The network card may, for example, send status information, accounting information or other information to a central controller, server or database and receive data or commands from the central controller, server or database.

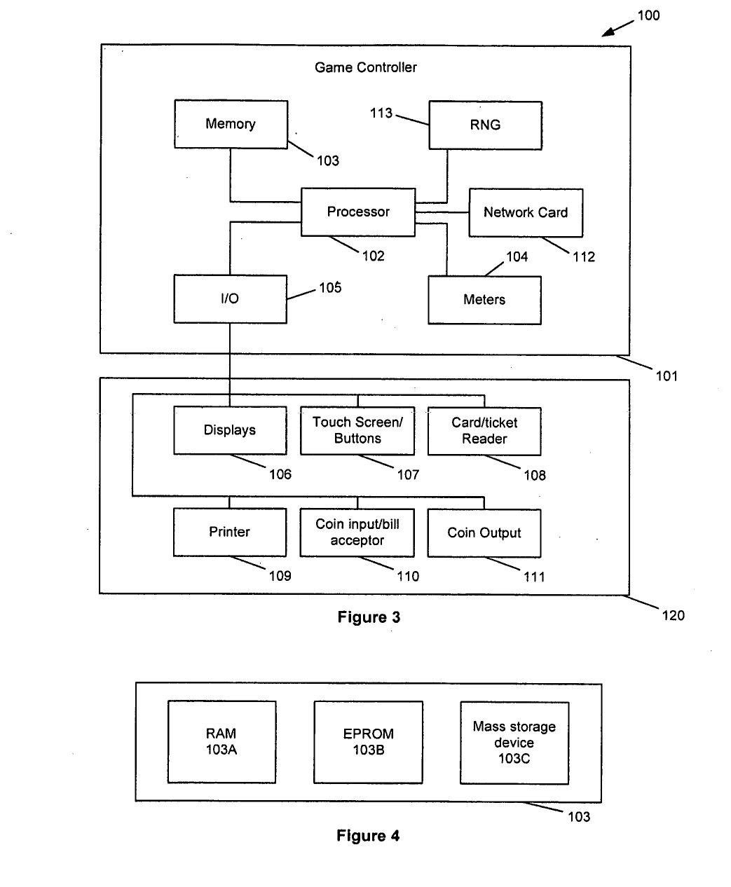

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111 to be provided remotely from the game controller 101.

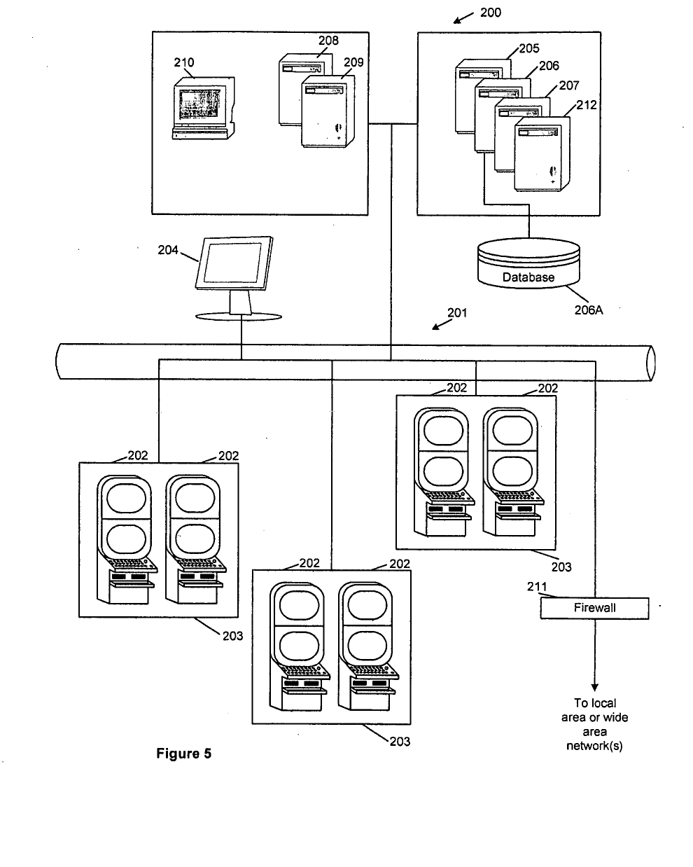

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 2 and 3, or may have simplified functionality depending on the requirements for implementing game play. While banks 203 of two gaming machines are illustrated in FIG. 5, banks of one, three or more gaming machines are also envisaged.

One or more displays 204 may also be connected to the network 201. For example, the displays 204 may be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to perform accounting functions for the Jackpot game. A loyalty program server 212 may also be provided.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming system 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of games servers could be provided to run different games or a single game server may run a plurality of different games as required by the terminals.

Embodiments of the current invention relate to systems that implement a game of video poker, where card symbols are presented face down or face up in a plurality, typically five, of display positions on the display.

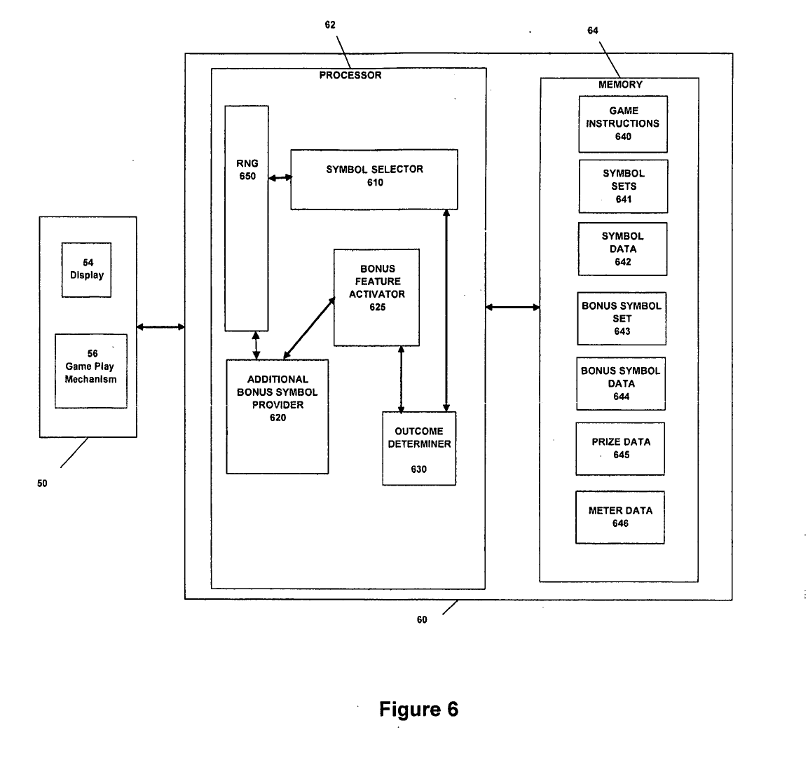

The game controller of one embodiment is shown in more detail in FIG. 6. Game controller 60 incorporates processor 62 and memory 64, and is operably connected with display 54 and game play mechanism 56. Processor 62 incorporates random number generator 650 connected to symbol selector 610 and additional bonus symbol provider 620. Symbol selector 610 and bonus symbol activator 625 provide data to outcome determiner 630. Memory 64 comprises game instructions 644, symbol sets 641 from which symbols are selected, symbol data 642 of the selected symbols, bonus symbol set 643 from which the bonus symbols are selected, bonus symbol data 644 recording the identity and position of all selected and distributed bonus symbols, prize data 645 containing the prizes for various winning combinations of the selected symbols and meter data 646 containing the aggregate prize outcomes determined by outcome determiner 630 as well as the player's credit balance.

Persons skilled in the art will appreciate that one or more of these components could be provided in other ways, for example by a dedicated circuit.

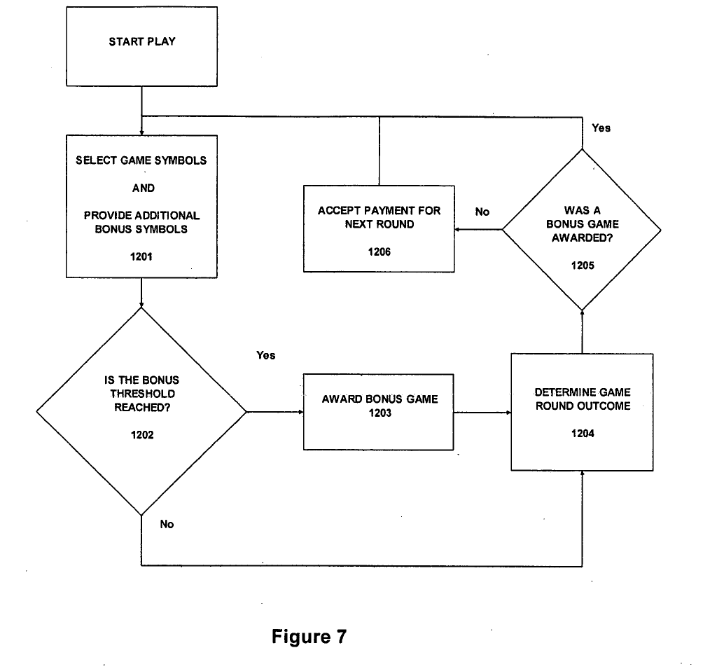

In an example of a game to which the invention is applied, with reference to FIG. 7, play is started by the player providing game credit, and in step 1201 the game symbols are selected from symbol set 641 by symbol selector 610 using random number generator 650. In one embodiment, the symbol set 641 may define a deck of cards. The selected symbols are stored a symbol data 642. In a typical embodiment, each card is selected (or drawn) independently, each card has an equal probability of being selected, and cards are removed from further draws once selected.

In addition, it is determined whether one or more additional bonus symbols are to be provided by additional bonus symbol provider 620 using random number generator 650 and the display positions at which they are to be provided. In one embodiment, all bonus symbols are the same. In another embodiment, there are a variety of different bonus symbols specified by bonus symbol set 643. In one embodiment, the bonus symbol provider 620 determines whether a bonus symbol should be provided independently for each display position; and the odds of a bonus symbol being selected for any position are adjusted to give a desired probability of certain numbers of bonus symbols being selected. In another embodiment, the trial conducted by random number generator is to determine the number of bonus symbols to be displayed across the display positions. In some embodiments more than one bonus symbol may be associated with a display position.

These steps are exemplified in detail in example 1 below. In step 1202 bonus feature activator 625 determines whether the number of additional bonus symbols provided is greater than the bonus threshold, and if so, records in step 1203 that the bonus feature is activated in this case the award of a bonus game on the next round. Another example is the award of a bonus multiplier. In this example, step 1202 is shown as occurring after the game symbol selection in step 1201, but in many examples of multi-step game rounds such as draw poker, the distribution of bonus symbols will occur in parallel with the steps of the game round. In one exemplary embodiment, the bonus feature may be activated after the initial deal of draw poker, or if it has not been activated, the player's decision to draw a card which can result in the award of the bonus feature. That is, in one embodiment, for each card that is redrawn a determination may be made by additional bonus symbol provider 620, using random number generator 650, whether a further bonus symbol should be selected at the display position corresponding to the card which is replaced. In step 1204, the game round outcome is determined, on the basis of the selected symbols and optionally activation of the bonus feature. In step 1205 and 1206, the player is given a free game for the next game round if the bonus feature was awarded.

### Example 1

A detailed example of an embodiment of the invention will now be described.

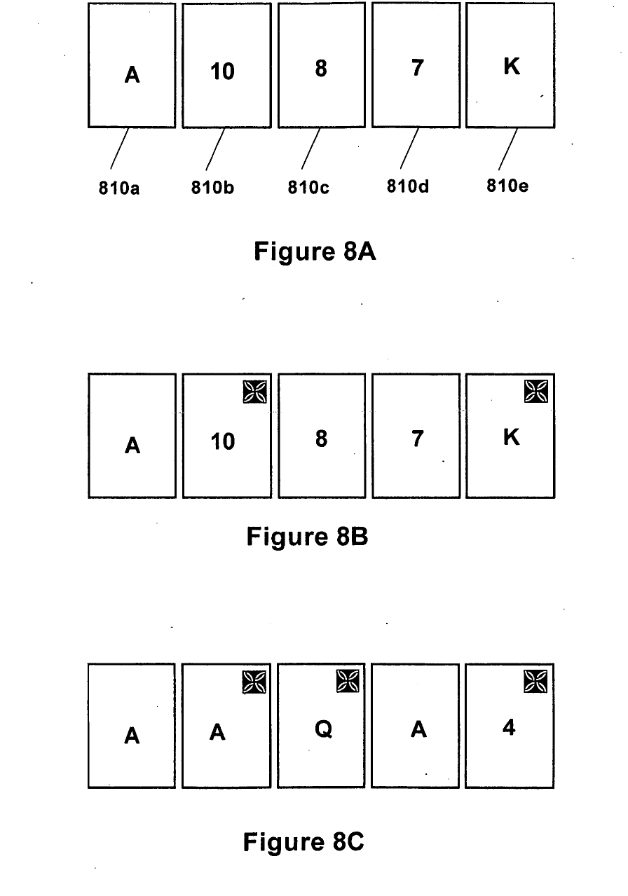

Referring now to FIG. 8A, a display during a round of video poker is shown. The 5 display positions 810a to 810e are shown each with card symbols displayed. These cards are selected from a symbol. At this point the “cards” are not necessarily fixed, or held in the hand. In FIG. 8B is shown the display a short time later, where two additional bonus symbols can be seen in the upper right corner provided on two of the display positions, 810b and 810e. The additional bonus symbols have been provided according to a random selection made using random number generator 650. In this embodiment the bonus symbols can appear on any display position, regardless of whether or not the cards are finally selected to be in the player's hand. The bonus threshold is three, so one more additional bonus symbol is required before the bonus feature, a free game round, is activated. An anticipatory sound or visual effect is presented to the player to alert them to the fact that if in the next game round step another additional bonus symbol appears, they will activate the bonus feature. The already provided bonus symbols stay in their display positions for the remainder of the game round. In this example, the player decides to replace four cards. In FIG. 8C is shown the final hand with the replaced cards, in the instance where the player is successful in activating the bonus feature. Note that in this example two of the bonus symbols are retained from the previous round and another random selection has determined that display position 810c will also receive an additional bonus symbol. That is, the game controller ahs determined whether or not to add bonus symbols at positions 810c and 810d. The total number of additional bonus symbols being three, equal to the bonus threshold, a triumphant sound or visual effect communicates the activation of the bonus feature to the player, being a free game round for the next round. Outcome determiner 630 also awards a prize for three Aces in the current game round and updates prize data 645, which in some embodiments may be increased by the fact of the bonus game having been awarded. It will thus be appreciated that in this example, the player's decision to replace cards to improve the poker hand does not have a negative effect on the player's position in respect of activating the bonus feature. In other embodiments, the replacement of a card could result in the removal of a bonus symbol from that position (which may then be replaced by another bonus symbol if it is determined that a bonus symbol should appear). In embodiments, where bonus symbols are retained independently of the cards, it may a fresh determination may be made for all replaced cards (such that there may be more than one bonus symbol at a position) or only for those where the bonus symbol has not been previously selected.

An advantage of this embodiment, it combines the popularity of a video poker card game with an additional game.

An advantage of certain embodiments resides in the concept of the bonus threshold, which means that bonus symbols can appear more frequently and increase player excitement and anticipation since the bonus feature is not activated unless the threshold number of symbols appear during the round.

An advantage of certain embodiments, is that the player can purse the best poker hand without having a negative effect on activation of the bonus feature.

The application of the invention to poker is not restricted to any particular temporal coincidence of the steps of the poker had and the possible appearance of bonus symbols. While in some embodiments the appearance of the symbols is timed to occur gradually to increase player anticipation, in other embodiments the bonus symbols can appear together at the conclusion of the game round.

The invention is also not restricted to any particular form of the bonus symbol, which is intended to encompass other symbolic indicators such as colour change, dynamic flashing effects, or border effects associated with a specific display position. Any visual indicator that informs the player that a display position has been provided with an analogous benefit is thus an additional bonus symbol within the scope of the invention. One particularly, advantageous bonus symbol is to provide a border around the basic symbol, for example a border of fire, indicating a “hot” position.

As is known in the art, the alteration of odds by virtue of the benefits of the bonus feature activation can be compensated by removing a fraction of a prize on the determination of each game round outcome, or by credit provided by “ante bet” to made by the player before play commences.

In some embodiments, an eligibility criteria may be applied, for example that the player has made a certain sized wager, made an ante bet, selected all win lines, played sufficient games, or the player is a member of a loyalty program.

The bonus symbols may only be available at certain stages of a game, for example in response to a trigger event such as a symbol combination in the game, occurrence of a specific symbol in the game, purchased, be caused by another connected system, based on turnover etc.

Persons skilled in the art will appreciate that the method of the embodiment could be embodied in program code. The program code could be supplied in a number of ways, for example on a computer readable medium, such as a disc or a memory (for example, that could replace part of memory 103) or as a data signal (for example, by downloading it from a server).

Persons skilled in the art will also appreciate that many variations may be made to the invention without departing from the scope of the invention. In particular, that additional embodiments may be formed by combining features from the above embodiments and examples.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

1. A method of gaming comprising:
selecting a set of symbols for display to a player in a set of display positions;
determining whether to provide an additional bonus symbol in association with one or more of the display positions;
activating a bonus feature if a number of bonus symbols is at least a bonus threshold; and
determining a game round outcome based at least on the selected symbols.

2. A method of gaming as claimed in claim 1 wherein the symbols selected for display are symbols of playing cards for an initial deal of poker.

3. A method of gaming as claimed in claim 2 wherein the player may replace one or more cards in subsequent deals and the method comprises determining in respect of each replaced card whether to provide a bonus symbol at its corresponding display position.

4. A method of gaming as claimed in claim 1 wherein the bonus threshold is three.

5. A method of gaming as claimed in claim 1 wherein the step of activating the bonus feature comprises awarding at least one free game round.

6. A method of gaming as claimed in claim 1 wherein the step of determining the game round outcome is also based on the bonus feature.

7. A method of gaming as claimed in claim 6 wherein the step of determining the game round outcome comprises increasing prize amounts if the bonus feature is activated.

8. A method of gaming as claimed in claim 1 wherein a plurality of additional bonus symbols may be provided at each display position.

9. A method of gaming as claimed in claim 1 wherein each bonus symbol surrounds the selected symbol at the display position.

10. A gaming system comprising:
a display for symbols to be displayed in a set of display positions to a player;
a symbol selector for selecting a set of symbols for display in the display positions;
an additional bonus symbol provider for providing a one or more additional bonus symbols associated with one of more of the display positions in response to determining that one or more additional bonus symbols should be provided;
a bonus feature activator for activating a bonus feature if a number of additional bonus symbols provided is at least a bonus threshold; and
an outcome determiner for determining a game round outcome based at least on the selected symbols.

11. A gaming system as claimed in claim 10 wherein the symbol selector is adapted to select symbols of playing cards for an initial deal of poker.

12. A gaming system as claimed in claim 11 wherein the player may replace one or more cards in subsequent deals and the additional bonus symbol provider is adapted to determine in respect of each replaced card whether to provide an additional bonus symbol at its corresponding display position.

13. A gaming system as claimed in claim 10 wherein the bonus threshold is three.

14. A gaming system as claimed in claim 10 wherein the bonus feature activator is adapted to award at least one free game round.

15. A gaming system as claimed in claim 10 wherein the game round outcome determiner is adapted to determine the game round outcome also on the basis of the bonus feature.

16. A gaming system as claimed in claim 15 wherein the game round outcome determiner is adapted to increase prize amounts if the bonus feature is activated.

17. A gaming system as claimed in claim 10 wherein the additional bonus symbol provider is adapted to provide a plurality of additional bonus symbols associated with a display position.

18. A gaming system as claimed in claim 10 wherein the additional bonus symbol provider is adapted to provide each bonus symbol such that it surrounds the selected symbol at the display position.

19. A gaming system as claimed in claim 10, comprising a game play mechanism operable by a player to make a wager and initiate a play of the game.

20. A gaming system as claimed in claim 10, comprising a processor arranged to execute code stored in a memory to implement the symbol selector, additional symbol provider, bonus feature activator and outcome determiner.

21. A game controller comprising
a symbol selector for selecting a set of symbols for display on a display to a player in a set of display positions;
an additional bonus symbol provider for providing a one or more additional bonus symbols associated with one of more of the display positions in response to determining that one or more additional bonus symbols should be provided;
a bonus feature activator for activating a bonus feature if a number of additional bonus symbols provided is at least a bonus threshold; and
an outcome determiner for determining a game round outcome based at least on the selected symbols.

22. A game controller as claimed in claim 21 wherein the symbol selector is adapted to select symbols of playing cards for an initial deal of poker.

23. A game controller as claimed in claim 22 wherein the player may replace one or more cards in subsequent deals and the additional bonus symbol provider is adapted to determine in respect of each replaced card whether to provide an additional bonus symbol at its corresponding display position.

24. A game controller as claimed in claim 21 wherein the bonus threshold is three.

25. A game controller as claimed in claim 21 wherein the bonus feature activator is adapted to award at least one free game round.

26. A game controller as claimed in claim 21 wherein the game round outcome determiner is adapted to determined the game round outcome also on the basis of the bonus feature.

27. A game controller as claimed in claim 26 wherein the game round outcome determiner is adapted to increase prize amounts if the bonus feature is activated.

28. A game controller as claimed in claim 21 wherein the additional bonus symbol provider is adapted to provide a plurality of additional bonus symbols associated with a display position.

29. A game controller as claimed in claim 21 wherein the additional bonus symbol provider is adapted to provide each bonus symbol such that it surrounds the selected symbol at the display position.

30. A game controller as claimed in claim 21 wherein at least one of the symbol selector, the additional bonus symbol provider, the bonus feature activator and the outcome determiner is implemented at least in part, by a processor executing code stored in a memory.

31. A gaming system comprising:
means for displaying symbols in a set of display positions to a player;
means for selecting a set of symbols for display in the display positions;
means for providing a one or more additional bonus symbols associated with one of more of the display positions in response to determining that one or more additional bonus symbols should be provided;
means for activating a bonus feature if a number of additional bonus symbols provided is at least a bonus threshold; and
means for determining a game round outcome based at least on the selected symbols.

32. An electronic gaming machine comprising:
a display for displaying a game including displaying symbols in a set of display positions to a player;
at least one input device operable to initiate a play of the game;
a game controller comprising a processor and a memory storing computer readable instructions, the processor executing the program code to implement the game in which the game controller selects a set of symbols for display in the display positions, the game controller determines whether one or more additional bonus symbols should be provided, the game controller provides one or more additional bonus symbols associated with one of more of the display positions in response to determining that one or more additional bonus symbols should be provided, the game controller activates a bonus feature if a number of additional bonus symbols provided is at least a bonus threshold, and the game controller determines a game round outcome based at least on the selected symbols.

33. A method according to claim 1 and further including a computer program code.

34. A method according to claim 33 and further including computer readable medium comprising said program code.

35. A method according to claim 33 and further including a data signal comprising said computer program code.

36. A method according to claim 33 and further including receiving or transmitting said computer program code.
